(19) United States
(12) Patent Application Publication
(10) Pub. No.: US 2024/0005084 A1
(43) Pub. Date: Jan. 4, 2024

(54) DYNAMIC ELECTRONIC DOCUMENT CREATION ASSISTANCE THROUGH MACHINE LEARNING

(71) Applicant: INTUIT INC., Mountain View, CA (US)

(72) Inventors: Omer ZALMANSON, Tel-Aviv (IL); Yair HORESH, Kfar-Saba (IL)

(21) Appl. No.: 17/809,658

(22) Filed: Jun. 29, 2022

(51) Int. Cl. G06F 40/166; G06N 5/04; G06N 5/02

(52) U.S. Cl. CPC G06F 40/166; G06N 5/04; G06N 5/022

(57) ABSTRACT

Aspects of the present disclosure relate to electronic document creation assistance. Embodiments include determining a current time related to creation of a document by a user and providing inputs to a machine learning model based on the current time. Embodiments include receiving output from the machine learning model based on the inputs and selecting, based on the output, a first recommended item from a plurality of items for inclusion in the document. Embodiments include determining a likelihood of each additional item of the plurality of items co-occurring with the first recommended item based on historical item co-occurrence data. Embodiments include selecting, based on the output and the likelihood of each additional item of the plurality of items co-occurring with the first recommended item, a second recommended item for inclusion in the document and providing, via a user interface, the first recommended item and the second recommended item to the user.

### INTRODUCTION

Aspects of the present disclosure relate to techniques for automatic completion of documents such as invoices and forms in software applications. In particular, techniques described herein involve utilizing machine learning techniques in a dynamic, iterative manner to predict items for inclusion in an electronically-created document such as an invoice or form.

### BACKGROUND

Every year millions of people, businesses, and organizations around the world utilize software applications to assist with countless aspects of life. For example, many businesses rely on software applications for creating invoices and billing customers for products and services. Some software applications provide user interfaces that are configured to allow users to create invoices, such as by entering information such as a customer name, identifying information of an item or service, a quantity, a rate (e.g., cost per unit of an item or service), and the like via user interface controls.

Utilizing software applications to create invoices and other types of documents with conventional techniques may be a time-consuming, repetitive, and inefficient process. As such, there is a need in the art for improved techniques of electronic document creation.

### BRIEF SUMMARY

Certain embodiments provide a method for electronic document creation assistance. The method generally includes: determining a current time related to creation of a document by a user; providing one or more inputs to a machine learning model based on the current time; receiving one or more outputs from the machine learning model based on the one or more inputs; selecting, based on the one or more outputs, a first recommended item from a plurality of items for inclusion in the document; determining a respective likelihood of each additional item of the plurality of items co-occurring with the first recommended item based on historical item co-occurrence data; selecting, based on the one or more outputs and the respective likelihood of each additional item of the plurality of items co-occurring with the first recommended item, a second recommended item for inclusion in the document; and providing, via a user interface, the first recommended item and the second recommended item to the user.

Other embodiments provide a method for training a machine learning model. The method generally includes: determining a plurality of items included in a plurality of documents associated with a user; determining creation times of the plurality of documents; generating training data for a machine learning model, the training data comprising: training inputs based on the creation times of the plurality of documents; and labels based on whether each given item of the plurality of items is included in each given document of the plurality of documents; and training the machine learning model using the training data by: providing one or more inputs to the machine learning model based on the training inputs; receiving one or more outputs from the machine learning model based on the one or more inputs; and adjusting one or more parameters of the machine learning model based on comparing the one or more outputs to one or more of the labels.

Other embodiments provide a system comprising one or more processors and a non-transitory computer-readable medium comprising instructions that, when executed by the one or more processors, cause the system to perform a method. The method generally includes: determining a current time related to creation of a document by a user; providing one or more inputs to a machine learning model based on the current time; receiving one or more outputs from the machine learning model based on the one or more inputs; selecting, based on the one or more outputs, a first recommended item from a plurality of items for inclusion in the document; determining a respective likelihood of each additional item of the plurality of items co-occurring with the first recommended item based on historical item co-occurrence data; selecting, based on the one or more outputs and the respective likelihood of each additional item of the plurality of items co-occurring with the first recommended item, a second recommended item for inclusion in the document; and providing, via a user interface, the first recommended item and the second recommended item to the user.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example user interface screen related to dynamic electronic document creation assistance.

FIG. 2 is an illustration of an example related to dynamic electronic document creation assistance.

FIG. 3 is an illustration of an iterative machine learning process for dynamic electronic document creation assistance.

FIG. 4 depicts an example related to dynamic electronic document creation assistance.

FIG. 5 depicts example operations related to dynamic electronic document creation assistance.

FIG. 6 depicts example operations related to training a machine learning model for dynamic electronic document creation assistance.

FIG. 7 depicts an example processing system for dynamic electronic document creation assistance.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for dynamic electronic document creation assistance.

A software application may allow for the creation of documents (e.g., invoices, bills, receipts, refund documents, and/or the like), such as via a user interface with various controls that allow information related to the document to be entered by a user. In an example, a user enters identifying information of a customer, an item or service, a quantity, a rate, and/or the like via a user interface, and the application creates an invoice based on the entered information. Creating documents such as invoices can be an inefficient and repetitive process, particularly for larger businesses that create many invoices. Often, a business may create many invoices with the same or similar items, particularly when doing business repeatedly with particular customers.

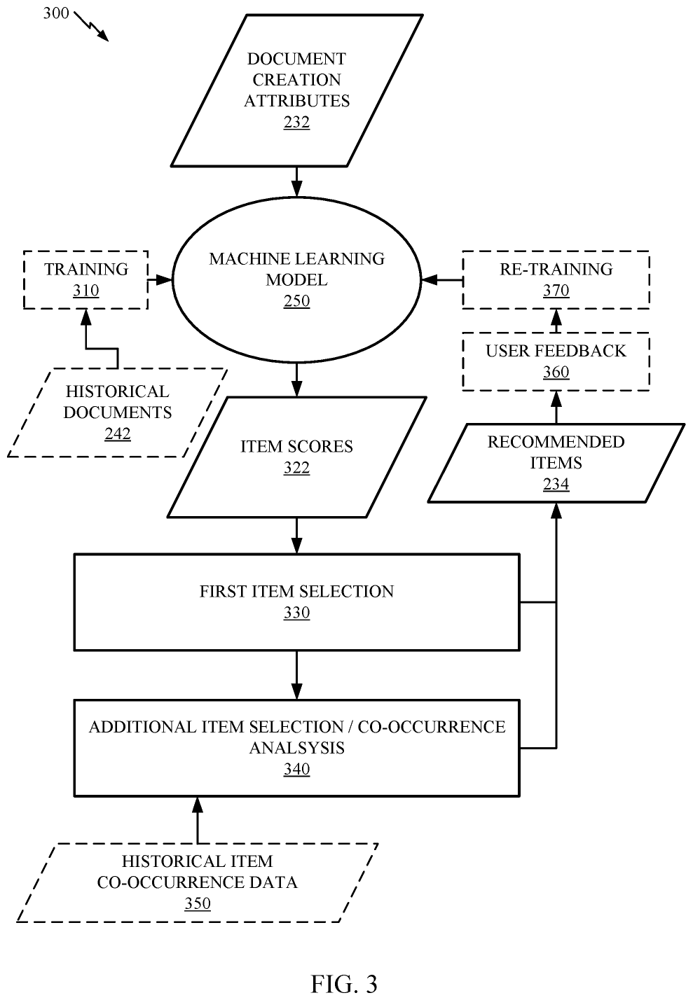

According to embodiments of the present disclosure, a dynamic, iterative machine learning process is used to automatically assist users with creation of documents such as invoices. For example, historical documents of a user may be used to train a machine learning model to predict items (e.g., indicating products or services) that the user will add to new documents (e.g., invoices) based on attributes such as document creation time (e.g., a time and/or date at which a document is created), a party related to the document (e.g., a customer to which an invoice corresponds), and/or the like. In a particular example, techniques described herein are used to recommend items for inclusion in an invoice as a user (e.g., representing a business) creates the invoice via a user interface. As used herein, an “item” refers to an entity that can be included in a document, such as a product or service from a user's inventory, a content item, a string, a word, a character, a number, and/or the like. Machine learning models and corresponding training processes are described in more detail below with respect to FIG. 3. In some embodiments, the machine learning model outputs scores for each item in the user's inventory based on attributes related to creation of a new document, such as the time at which the new document is being created. A score output by the machine learning model for a given item indicates a likelihood that the given item should be included in the document that is being created.

Embodiments of the present disclosure involve selecting multiple items for recommendation to the user (e.g., the user may be provided with recommendations to add each of the multiple items to the document that the user is creating). A first recommended item may be selected based on the scores (e.g., an item with a highest score may be selected) After the first recommended item is selected, additional items may be selected for recommendation based not only on the scores, but also based on the likelihood of those additional items co-occurring with items that have been previously selected for recommendation. The first recommended item cannot be selected based on a co-occurrence likelihood with other selected items because no items have been previously selected for recommendation at that point. However, subsequent items may be selected for recommendation based on the items' co-occurrence likelihoods with respect to previously-selected items. For example, historical documents of the user may be analyzed to determine frequencies with which pairs of items in the user's inventory historically co-occurred in the same historical document. For instance, after a first recommended item is selected based on the scores, selecting a second item for recommendation may involve multiplying a co-occurrence measure with respect to the first item for each given item other than the first item with a score output by the model for the given item to produce a “dynamic” score for the given item (e.g., a score that is dynamically calculated based on the item previously selected). In an example, the second item selected for recommendation is the item with the highest dynamic score. This process may be repeated until some condition is met, such as determining that there are no remaining items with scores and/or dynamic scores above a threshold. Thus, techniques described herein involve recommending a set of items for inclusion in the document that are likely to be relevant to the document and that are also likely to co-occur with one another, and not recommending items that are unlikely to be relevant to the document (e.g., as indicated by low scores) and/or are unlikely to co-occur with other recommended items (e.g., as indicated by low dynamic scores).

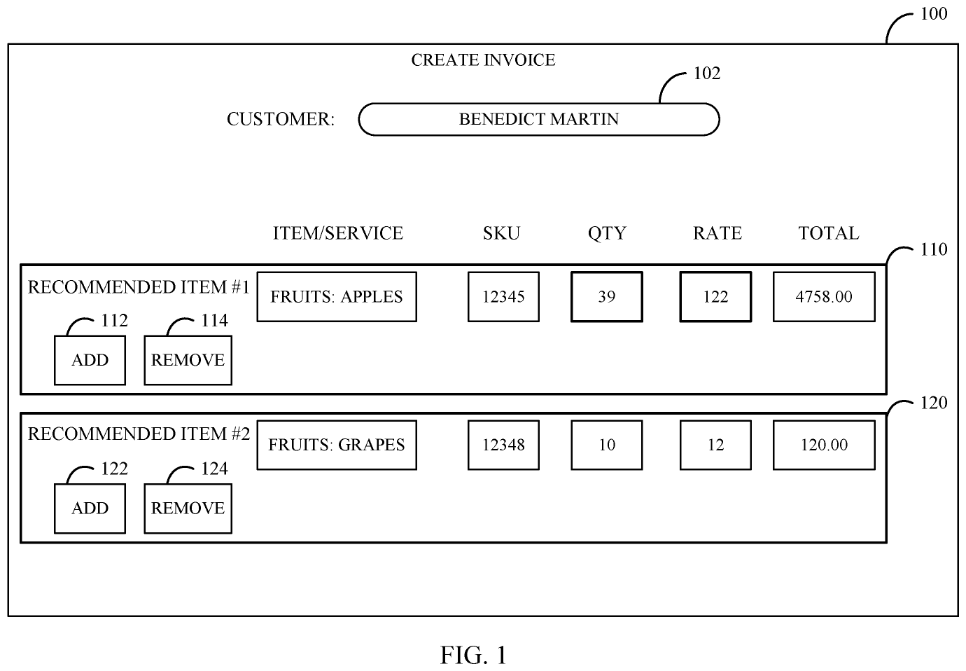

Items selected for recommendation may be displayed to a user via a user interface, as described in more detail below with respect to FIG. 1. In some cases, recommendations may be updated as additional input is received from the user. For example, if the user provided additional input identifying a party related to the document (e.g., a customer to which an invoice corresponds), updated inputs may be provided to the machine learning model based on the party, and the recommendations may be updated accordingly (e.g., based on new scores output by the machine learning model and co-occurrence measures through the iterative process described herein). In another example, if a user provides feedback accepting or declining a recommended item (e.g., an item from the user's inventory that is recommended for inclusion in an invoice that the user is creating), that feedback may be used to update the remaining recommendations and/or may be used to re-train the model for improving future recommendations. For instance, if the user declines a recommended item, then additional recommended items may be updated (e.g., to no longer take into account any co-occurrence measures with respect to the declined item).

It is noted that while certain embodiments are described herein with respect to invoices, assistance with creation of other types of documents may also be provided using techniques described herein. For example, the dynamic, iterative machine learning process described herein for recommending items for inclusion in a document may be utilized with any type of document created by adding items from a known set of items that are also included in historical documents of the same type. Examples of other types of documents for which embodiments of the present disclosure may be employed include forms, estimates, bills, refund documents, receipts, and/or the like.

In some embodiments, techniques described herein may be utilized in conjunction with other technical processes such as optical character recognition (OCR). For example, if OCR is used to extract items from an image of a document, the items in the document may also be predicted using the dynamic, iterative machine learning process described herein based on historical documents of the type for which the items are known, and the predicted items may be used to enhance the OCR-based item extraction process. For instance, if the OCR data (e.g., data extracted using OCR) for a given item matches a predicted item, then the confidence for that extraction may be increased, and the OCR data may be used. If OCR data for a given item is close to the predicted item but off by a small amount (e.g., fewer than a threshold number of characters are different), then the predicted item data may be used instead of the OCR data. If the OCR data is significantly different than a predicted item (e.g., more than a threshold number of characters are different), then additional processing may be performed to confirm that the OCR data is accurate, such as comparing the OCR data to other predicted items for the document, re-performing OCR with different parameters, prompting the user to capture a new image of the document, presenting the OCR data to the user for manual confirmation, and/or the like.

Furthermore, while some embodiments described herein involve recommending items to a user for inclusion in a document, other embodiments may involve automatically populating a document with items predicted using techniques described herein (e.g., if the scores and/or dynamic scores of the items exceed a threshold).

Embodiments of the present disclosure provide multiple improvements over conventional techniques for electronic document creation. For example, by utilizing the dynamic, iterative machine learning techniques described herein to recommend items for inclusion in a document, embodiments of the present disclosure allow for a significant reduction in time, repetition, and computing resource utilization (e.g., utilization of resources such as processing, memory, display, input device, etc.) that would otherwise be associated with the manual creation of the document through interaction with a user interface. Furthermore, by augmenting outputs from a machine learning model with co-occurrence measures dynamically based on each successively selected item for recommendation in an iterative loop, techniques described herein improve upon machine learning models by adding an additional real-time, dynamic component. By utilizing input and feedback from the user to iteratively improve item recommendations and the machine learning model (e.g., by updating recommendation as additional user input is received and/or by re-training the machine learning based on user feedback), techniques described herein provide a continuously-improving feedback loop. Additionally, the dynamic, iterative machine learning techniques described herein allow for providing real-time recommendations of items for inclusion in a document as the document is being created in a manner that could not be practically performed in the human mind.

Additionally, techniques described herein may avoid errors that could otherwise be introduced through the manual creation of documents, thereby avoiding processing, storage, and communication resource utilization associated with auditing, correcting and/or re-sending documents created using software applications.

While certain components of the techniques described herein may be known, embodiments of the present disclosure involve combinations of these components that provide benefits beyond the benefits separately provided by each individual component. For instance, while machine learning techniques in a general sense may be known in the art, and while the use of probabilistic data for predictions in a general sense may be known the art, techniques described herein utilize a dynamic combination of these components where the output from a machine learning model for each subsequently selected item for recommendation is combined with probabilistic data related to item co-occurrence with respect to previously-selected items, thereby selecting items for recommendation that are based not only on machine learning and probability, but also based on previously-selected items in an iterative loop. As such, techniques described herein provide item recommendations that are more dynamically informed and therefore more accurate than recommendations that could otherwise be produced by a general machine learning model or through conventional probabilistic analysis.

### Example User Interface Screen Related to Dynamic Electronic Document Creation Assistance

FIG. 1 depicts an example user interface screen 100 related to dynamic electronic document creation assistance. For example, screen 100 may be associated with a software application that allows users to manage various business tasks, such as creation of invoices and other types of documents. In some cases, screen 100 may be associated with a user interface running on a computing device, such as a desktop computer, laptop computer, mobile phone, tablet, or the like.

Screen 100 provides various user interface controls and components related to creating an invoice, such as to bill a customer for items or services. Control 102 allows a customer name to be entered. Components 110 and 120 include recommended items for inclusion in the invoice, and include controls 112, 114, 122, and 124 for adding or removing the recommended items (e.g., accepting or rejecting the recommendations).

In some cases, various controls in screen 100 may allow the user to select an element from a list. For example, control 102 may, when selected, cause a list of customers to be displayed as options to be selected.

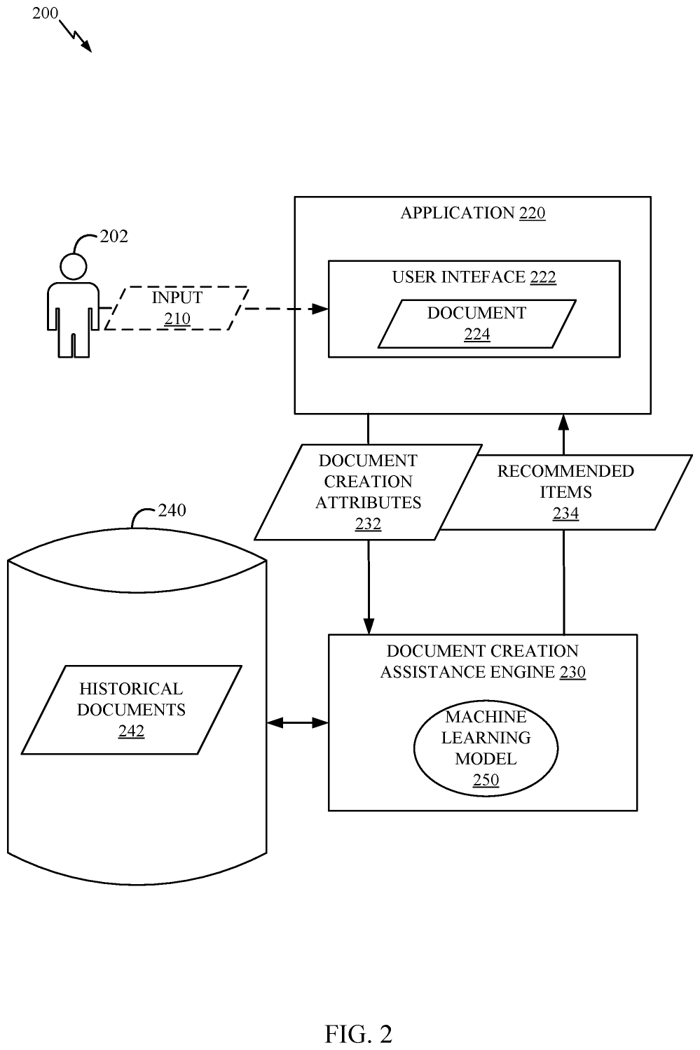

According to embodiments of the present disclosure, dynamic electronic document creation assistance is performed during invoice creation within screen 100. In an example, as described in more detail below with respect to FIG. 2, one or more attributes related to the creation of the document, such as the current time and/or date (e.g., document creation time), the customer indicated in control 102 (e.g., if a customer has been identified), and/or the like, are provided as inputs to a machine learning model. In some embodiments the machine learning model is specific to the user that is creating the document, while in other embodiments the machine learning model is trained for a plurality of users, and one or more attributes of the user are provided as inputs to the machine learning model. The machine learning model outputs scores for each of a plurality of items (e.g., apples and grapes) in the user's inventory. One or more recommended items for inclusion in the document are then determined based on the scores output by the model and, in some cases (e.g., for items after the first recommended item), based on item co-occurrence probabilities.

In the example depicted in screen 100, the user has entered the customer name “Benedict Martin”. As such, the customer name may be used as an input feature for the machine learning model. Furthermore, the current time at which invoice creation is being performed may also be used to determine input features for the model. The model may be trained based on historical invoices of the user to predict likelihoods of items appearing in an invoice given features such as invoice creation time, customer, and/or the like.

Recommended item #1 (having the name “FRUITS: APPLES”, the SKU “12345”, and the rate “122”) depicted in component 110 may be selected for recommendation based on the scores output by the model such as based on determining that a score for the item is the highest of scores for all items and/or based on determining that the score for the item exceeds a threshold. In some embodiments, a quantity of the item is also predicted using one or more machine learning models, while in other embodiments the quantity is entered by the user (e.g., after a recommendation of the item is accepted by the user and the item is added to the document). The total is calculated based on the rate of the item (e.g., as indicated in the user's inventory) and the quantity.

Recommended item #2 (having the name “FRUITS: GRAPES”, the SKU “12348”, and the rate “12”) depicted in component 120 may be selected based on the scores output by the model and also based on co-occurrence probabilities. For example, the probability of each item in the user's inventory other than item #1 appearing in the same invoice as item #1 may be determined based on historical invoices of the user. A dynamic score may then be calculated for each given item based on the score output by the model for the given item and the likelihood of the given item co-occurring with item #1. Item #2 may be selected based on determining that it has a highest dynamic score of the remaining items and/or based on determining that its score and/or dynamic score exceed one or more thresholds.

While not depicted, one or more additional items may also be recommended. For example, a third item may be recommended based on the score output by the model for the third item and a likelihood of the third item co-occurring with item #2 (and, in some embodiments, item #1).

The user may add item #1 to the invoice by selecting control 112 or may decline the recommendation of item #1 by selecting control 114. Similarly, the user may add item #2 to the invoice by selecting control 122 or may decline the recommendation of item #2 by selecting control 124.

In some embodiments, user input is used to update the recommendations and/or to re-train the machine learning model. In one example, if the user selects control 114 to decline the recommendation of item #1, additional recommendations may be updated based on the user input. For instance, the item with the next highest score output by the model may be selected as the new first recommendation (e.g., replacing item #1 as the first recommended item), dynamic scores may be re-calculated for all remaining items based on the selection of the new first recommendation, and an item with a highest dynamic score may be selected as the new second recommendation (e.g., replacing item #2 as the second recommended item if item #2 is no longer the item with the highest dynamic score), and so on. If the user selects control 124 to decline the recommendation of item #2, additional recommendations may be updated based on the user input. For instance, dynamic scores may be re-calculated for all remaining items based on the removal of the recommendation of item #2, and an item with a highest dynamic score may be selected as the new second recommendation (e.g., replacing item #2 as the second recommended item), and so on.

Furthermore, feedback provided by the user, such as via controls 112, 114, 122, and/or 124, may be used to re-train the machine learning model. For example, once the user adds recommended items and/or declines recommendations and completes the invoice, the invoice may be added to the set of historical invoices used to generate training data. Updated training data may be generated based on the invoice, and the machine learning model may be re-trained based on the updated training data for improved subsequent recommendations.

It is noted that screen 100 is included as an example of a user interface screen, and other types of user interfaces with different types of controls and/or components may be utilized with embodiments of the present disclosure.

### Dynamic Electronic Document Creation Assistance

FIG. 2 is an illustration 200 of an example related to dynamic electronic document creation assistance.

Illustration 200 includes an application 220, which generally represents a software application that provides functionality related to creation of documents such as invoices.

In some embodiments, application 220 is associated with a user interface, such as user interface screen 100 of FIG. 1, which allows a user 202 to create a document 224. Document 224 generally represents a document created based on input 210 from user 202, and may include values related to items and/or services for which a customer is billed. User 202 provides input 210 via the user interface, such as by entering data related to a customer and/or items and/or by accepting and/or declining recommendations of items determined using techniques described herein.

Application 210 provides one or more document creation attributes 232 related to the creation of document 224 to a document creation assistance engine 230. Document creation attributes 232 may include, for example, a time and/or date at which document 224 is being created (e.g., based on determining a current time and/or date), a party for which document 224 is being created (e.g., a customer to which an invoice corresponds), and/or the like. In some embodiments, document creation attributes 232 include one or more attributes of user 202, such as an identifier of user 202.

Document creation assistance engine 230 provides one or more inputs to machine learning model 250 based on document creation attributes 232. Machine learning model 250 may, for example, be a classification model that has been trained through supervised learning techniques based on historical documents 242, as described in more detail below with respect to FIG. 3, to output scores for items in an inventory of user 202 indicating a strength of association between the items and the creation of document 224.

In some embodiments, inputs provided to machine learning model 250 include an hour of document creation, a day of the week of document creation, and/or a day of the month of document creation. Furthermore, in some embodiments, inputs provided to machine learning model 250 include one or more scores determined based on the hour, day of the week, and/or day of the month of document creation relative to historical hours, days of the week, and/or days of the month associated with creation of historical documents 242. In one example, a circular z score is determined for each of the document creation hour, day of the week, and day of the month. A z score (also called a standard score) is generally calculated by subtracting a mean for a given data point (e.g., document creation hour) from a current value for the given data point (e.g., the current document creation hour) and dividing the remainder by a standard deviation for the given data point. A circular z score is determined by dividing a circular distance between the current value for the given data point and a circular mean for the given data point by a circular standard deviation for the given data point. A circular distance is the minimum distance between two values in a circle. For example, the circular distance between the hours 5:00 and 23:00 is 6, and not 18. Circular means and circular standard deviations are means and standard deviations designed for cyclic quantities, such as daytimes. For example, with a standard (non-circular) mean the “average time” between 23:00 and 1:00 is either midnight or noon, depending on whether the two times are part of a single night or part of a single calendar day. As is known in the art, determining a circular mean or a circular standard deviation generally involves determining an arithmetic mean and/or standard deviation of points on a circle that correspond to the values for which the calculation is being performed (e.g., hours, days of the week, days of the month, and/or the like). The circular mean and circular standard deviation may determined based on historical documents 242.

Inputs to machine learning model 250 may also include a party such as a customer associated with document 224 (e.g., if user 202 has identified the party). In some embodiments, machine learning model 250 is specific to user 202, while in other embodiments machine learning model 250 is common to a plurality of users. If machine learning model 250 is common to a plurality of users, inputs to machine learning model 250 may also include one or more attributes such as an identifier of user 202.

Document creation assistance engine 230 may select a first recommended item 234 based on scores output for items by machine learning model 250, such as by selecting an item with a highest score. In some embodiments, document creation assistance engine 230 only recommends an item if its score (or dynamic score) exceeds a threshold, thereby avoiding providing recommendations that are unlikely to be accepted by the user. Document creation assistance engine 230 may select a second recommended item based on the scores output by machine learning model 250 and also based on co-occurrence probabilities of other items with respect to the first recommended item 234. For instance, document creation assistance engine 230 may calculate a dynamic score for each given item other than the first recommended item 234 by multiplying a co-occurrence probability of the given item with respect to the first recommended item 234 by the score output by machine learning model 250. In some embodiments, document creation assistance engine 230 selects the item with the highest dynamic score as the second recommended item 234. This process may repeat until there are no additional items with scores and/or dynamic scores exceeding a threshold.

Document creation assistance engine 230 transmits recommended items 234 to application 220, and recommended items 234 may be displayed via user interface 222. User 202 may provide input 210 accepting and/or declining recommended items 234. In some embodiments, if user 202 provides input 210 accepting or rejecting a given recommended item 234, the other recommended items 234 are updated based on the input and/or machine learning model 250 may be re-trained based on the input.

In some embodiments, once document 234 is complete, document 234 is added to historical documents 242 in data store 240, and thereby informs future recommendations.

Document creation assistance engine 230 generally comprises one or more components that perform operations related to dynamic electronic document creation assistance. In some embodiments, document creation assistance engine 230 is part of application 210. In other embodiments document creation assistance engine 230 is separate from application 220, and is located either on the same device as application 220 or a separate device from application 220. In certain embodiments, a client-server architecture is utilized. For example, user 202 may interact with application 220 via a user interface provided on a client device (e.g., computer or mobile phone), and certain processing related to application 220, such as dynamic electronic document creation assistance operations performed by document creation assistance engine 230, may be performed on one or more remote devices (e.g., a server computer) connected to the client device via a network. In other embodiments, all processing related to application 220 and document creation assistance engine 230 is performed on a single device.

Data store 240 generally represents a data storage entity such as a database or repository that stores data related to application 220 and/or document creation assistance engine 230. In some cases, historical documents 242 include only the historical documents of user 202, while in other cases historical documents 242 include historical documents of a plurality of users.

### Example Iterative Machine Learning Process for Dynamic Electronic Document Creation Assistance

FIG. 3 is an illustration 300 of an example iterative machine learning process for dynamic electronic document creation assistance. Illustration 300 includes document creation attributes 232, machine learning model 250, historical documents 242, and recommended items 234 of FIG. 2.

Machine learning model 250 generally represents a model such as a classification model that is trained through a training 310 process based on historical documents 242.

Machine-learning models allow computing systems to improve and refine functionality without explicitly being programmed. Given a set of training data, a machine-learning model can generate and refine a function that determines a target attribute value based on one or more input features. For example, if a set of input features describes an automobile and the target value is the automobile's gas mileage, a machine-learning model can be trained to predict gas mileage based on the input features, such as the automobile's weight, tire size, number of cylinders, coefficient of drag, and engine displacement.

Machine learning model 250 may, for example, be a binary classifier. In one example, machine learning model 250 is a tree-based classifier such as an XGBoost model. A tree model (e.g., a decision tree) makes a classification by dividing the inputs into smaller classifications (at nodes), which result in an ultimate classification at a leaf. Boosting, or gradient boosting, is a method for optimizing tree models. Boosting involves building a model of trees in a stage-wise fashion, optimizing an arbitrary differentiable loss function. In particular, boosting combines weak “learners” into a single strong learner in an iterative fashion. A weak learner generally refers to a classifier that chooses a threshold for one feature and splits the data on that threshold, is trained on that specific feature, and generally is only slightly correlated with the true classification (e.g., being at least more accurate than random guessing). A strong learner is a classifier that is arbitrarily well-correlated with the true classification, which may be achieved through a process that combines multiple weak learners in a manner that optimizes an arbitrary differentiable loss function. The process for generating a strong learner may involve a majority vote of weak learners. An XGBoost model is an example of a gradient boosted model.

Training 310 of machine learning model 250 may involve supervised learning techniques. In some embodiments, training data is generated based on historical documents 242. Training data instances may include, as training inputs, features related to creation of historical documents 342, such as document creation hour, day of week, and/or day of month, and/or scores determined based on the document creation hour, day of week, and/or day of month (e.g., circular z scores). Training inputs may also include identifiers of parties associated with historical documents 242 such as customers to which historical documents 242 correspond and/or users that created historical documents 242 (e.g., if machine learning model 250 is trained for multiple users). Labels of the training data instances may include indicators of whether individual items were included in the historical documents 242 described by the training inputs. For example, a single training data instance may include an hour, day of the week, and/or day of the month (and/or circular z scores based on the hour, day of the week, and/or day of the month) on which a given historical document 242 was created, an identifier of a customer to which the given historical document 242 corresponds, and/or an identifier of a given item, associated with a label indicating whether the given item was included in the given historical document 242. A size of a training data set (e.g., in rows) may be |N|×|M|, where N is the number of documents and M the number of items in a given user's inventory.

In some embodiments, training 310 involves providing training inputs to machine learning model 250. Machine learning model 250 processes the training inputs and outputs scores indicating likelihoods that given items will be included in the documents described by the training inputs. The outputs are compared to the labels associated with the training inputs to determine the accuracy of machine learning model 250, and parameters of machine learning model 250 are iteratively adjusted until one or more conditions are met.

For example, the conditions may relate to whether the predictions produced by machine learning model 250 based on the training inputs match the labels associated with the training inputs or whether a measure of error between training iterations is not decreasing or not decreasing more than a threshold amount. The conditions may also include whether a training interaction limit has been reached. Parameters adjusted during training may include, for example, hyperparameters, values related to numbers of iterations, weights, functions, and/or the like. In some embodiments, validation and testing are also performed for machine learning model 250, such as based on validation data and test data, as is known in the art. Machine learning model 250 may be trained either through batch training (e.g., each time a threshold number of training data instances have been generated) or through online training (e.g., re-training machine learning model 250 with each new training data instance as it is generated). Thus, machine learning model 250 may be continuously improved through re-training as new feedback is received from users.

Once machine learning model 250 is trained, it may be used to recommend items for inclusion in a new document. Document creation attributes 232 are used to provide inputs to machine learning model 250. Inputs provided to machine learning model 250 may include, for example, an hour, day of the week, and/or day of the month (and/or circular z scores based on the hour, day of the week, and/or day of the month) at which the new document is being created, an identifier of a customer to which the new document corresponds, and/or identifiers of items. Machine learning model 250 outputs item scores 322 based on the inputs. Item scores 322 generally indicate likelihoods that items will be included in the new document described by the inputs.

A first item selection 330 is performed based on item scores 322 to select a first recommended item 234. For example, first item selection 330 may involve selecting an item with a highest item score 322 (e.g., if there are any item scores 322 above a threshold).

Additional item selections 340 may be performed based on scores 322 and a co-occurrence analysis. For example, historical item co-occurrence data 350 may be determined based on historical documents 242, and may be used to determine probabilities that each item will co-occur in the same document with an item previously selected for recommendation. In a particular case, the second recommended item 234 is selected based on determining a probability that the second recommended item 234 will co-occur with the first recommended item 234, such as by multiplying the determined probability by the item score 322 for the second recommended item 234 to produce a dynamic score for the second recommended item 234. On each successive iteration, dynamic scores may be determined for all items other than a previously-selected item (or, in some embodiments, all previously-selected items), and an item with a highest dynamic score on each iteration may be selected as a next recommended item 234.

In some embodiments, historical item co-occurrence data 350 comprises an item co-occurrence matrix. A value in the item co-occurrence matrix may represent the conditional probability of an item (column) given another item that has been previously selected (row). In additional embodiments, historical item co-occurrence data 350 may also indicate the conditional probability of each item given a set of other items that have been previously selected. For example, historical item co-occurrence data 350 may include an indication of the probability of item 4 co-occurring with all of items 1, 2, and 3. Thus, each successive item may, in some embodiments, be selected based on its probability of co-occurring with some or all previously-selected items.

Recommended items 234 may be displayed to a user, and the user may provide user feedback 360 (e.g., accepting and/or denying each recommended item 234). User feedback 360 is used at a re-training 370 step to re-train machine learning model 250. For example, updated training data may be generated based on user feedback 360, and machine learning model 250 may be re-trained based on the updated training data in a similar manner to that described above with respect to training 310.

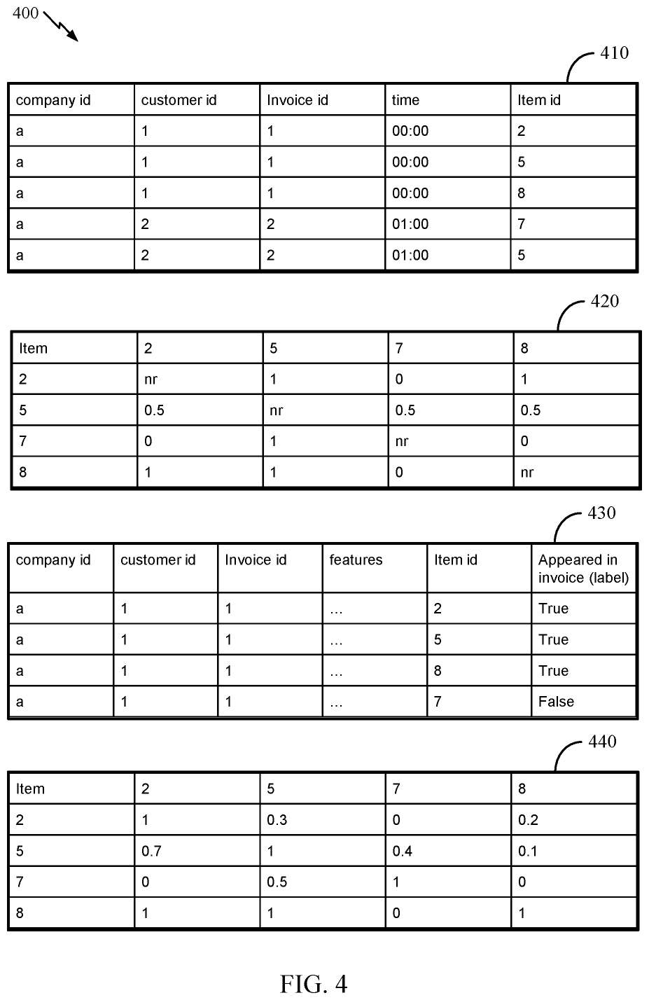

FIG. 4 is an illustration 400 of an example related to dynamic electronic document creation assistance.

Table 410 is an example of data extracted from historical invoices of a user according to embodiments of the present disclosure. For example, the user may correspond to a company having a company identifier of “a”. The data in table 410 was extracted from two invoices of business “a”, a first invoice “1” issued to a customer having the identifier “1” and a second invoice “2” issued to a customer having the identifier “2”. Invoice 1 was crated at time “00:00” and invoice 2 was created at time “01:00”. Items “2”, “5”, and “8” were extracted from invoice 1, and items “7” and “5” were extracted from invoice 2.

Table 420 is an example of a co-occurrence matrix based on the data in table 410. As shown in table 420, item 2 has a co-occurrence rate of 1 with item 5 (e.g., because item 5 also appears in 100% of the invoices that include item 2), 0 with item 7 (because item 7 appears in none of the invoices in which item 2 appears), and 1 with item 8 (because item 8 also appears in 100% of the invoices in which item 2 appears).

Item 5 has a co-occurrence rate of 0.5 with item 2 (e.g., because item 2 also appears in 50% of the invoices that include item 5), 0.5 with item 7 (because item 7 also appears in 50% of the invoices in which item 5 appears), and 0.5 with item 8 (because item 8 also appears in 50% of the invoices in which item 5 appears).

Item 7 has a co-occurrence rate of 0 with item 2 (e.g., because item 2 appears in none of the invoices that include item 7), 1 with item 5 (because item 5 also appears in 100% of the invoices in which item 7 appears), and 0 with item 8 (because item 8 appears in none of the invoices in which item 5 appears).

Item 8 has a co-occurrence rate of 1 with item 2 (e.g., because item 2 also appears in 100% of the invoices that include item 8), 1 with item 5 (because item 5 also appears in 100% of the invoices in which item 8 appears), and 0 with item 7 (because item 7 appears in none of the invoices in which item 8 appears).

Table 430 is an example a training data set for a machine learning model based on data in table 410. Each row in table 430 comprises a set of features for an invoice and an item with a corresponding label indicating whether the item appeared in the invoice represented by the features. For example, the features that are not depicted may include invoice creation time. Table 430 indicates that items 2, 5, and 8 appeared in invoice 1, while item 7 did not appear in invoice 1. The training data represented in table 430 may be used to train a machine learning model using techniques described above with respect to machine learning model 250 of FIG. 3.

Table 440 represents another example co-occurrence matrix based on alternative set of historical invoices. The values in table 440 represent the co-occurrence rates of items 2, 5, 7, and 8 with respect to one another in a hypothetical set of invoices (not shown), and are included for use in a working example.

In an example, a threshold k of 0.5 (e.g., meaning that no items with a score below 0.5 will be selected for recommendation) is used, and the co-occurrence matrix represented in table 440 is determined. Furthermore, in this example, the following scores are output by the model: [item 5=0.9; item 2=0.6; item 7=0.7; item 8=0.5].

Item 5 is selected for recommendation first, as it has the highest model score (0.9), and its model score is above the threshold k. To select the next item for recommendation, the model scores for the remaining items 2, 7, and 8, are multiplied by co-occurrence rates of the items with the first selected item (5). For example, the model score of item 2 (0.6) is multiplied by the co-occurrence rate of item 2 with item 5, which is 0.7 per table 440, resulting in a dynamic score of for item 2. The model score of item 7 (0.7) is multiplied by the co-occurrence rate of item 7 with item 5, which is 0.4 per table 440, resulting in a dynamic score of 0.28 for item 7. The model score of item 8 (0.5) is multiplied by the co-occurrence rate of item 8 with item 5, which is 0.1 per table 440, resulting in a dynamic score of 0.05 for item 8.

Assuming a threshold m of 0.1 (e.g., meaning that no items with a dynamic score below will be selected for recommendation), item 8 is eliminated since its dynamic score of 0.05 falls below 0.1.

According to certain embodiments, item 7 is selected next for recommendation, as it has the next highest model score of 0.7, which is above the threshold k. Given the selection of item 7, the model scores of remaining items are multiplied by co-occurrence rates of the items with the previously-selected item (7). In this case, only item 2 remains, since item 8 was eliminated. The model score of item 2 (0.6) is multiplied by the co-occurrence rate of item 2 with item 7, which is per table 440, resulting in a dynamic score of 0 for item 2. Item 2 is then eliminated, as its dynamic score of 0 falls below the threshold m.

With no items remaining to select, the final recommended set of items is {5, 7}.

### Example Operations for Dynamic Electronic Document Creation Assistance

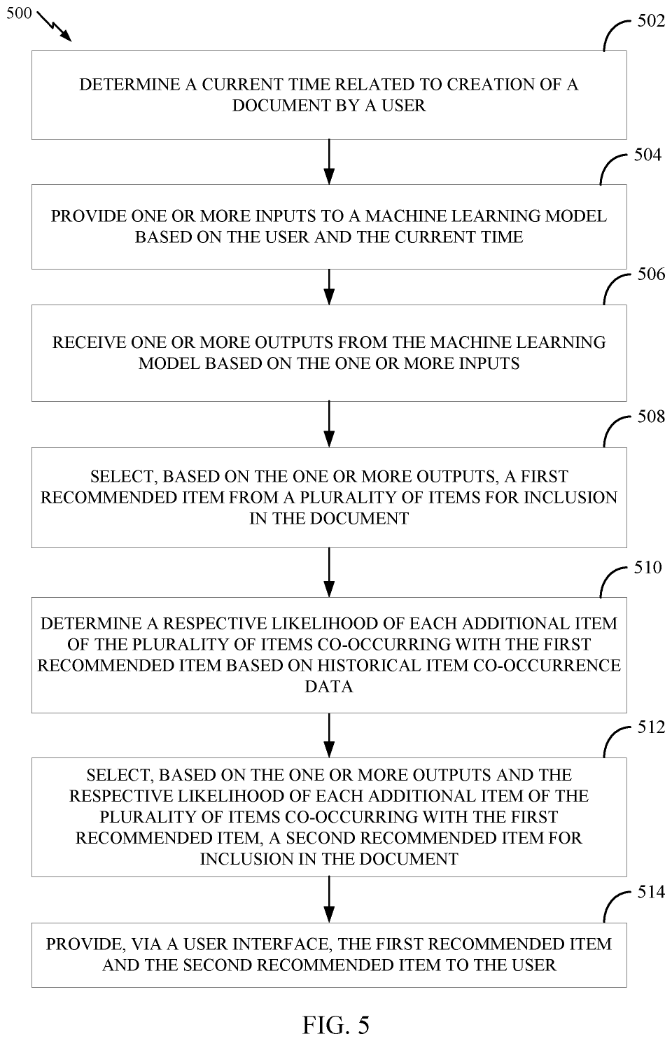

FIG. 5 depicts example operations 500 for dynamic electronic document creation assistance. For example, operations 500 may be performed by document creation assistance engine 230 and/or application 220 of FIG. 2.

Operations 500 begin at step 502 with determining a current time related to creation of a document by a user. The current time may include a second, minute, hour, day of week, day of month, day of year, and/or the like.

Operations 500 continue at step 504, with providing one or more inputs to a machine learning model based on the current time.

In some embodiments, the one or more inputs provided to the machine learning model comprise one or more of: an hour; a day of a month; a day of a week; a first score based on the hour and historical hours associated with historical documents; a second score based on the day of the month and historical days of months associated with the historical documents; or a third score based on the day of the week and historical days of weeks associated with the historical documents. In certain embodiments, the first score, the second score, and the third score comprise circular z scores.

In some cases, providing the one or more inputs to the machine learning model comprises receiving the input from the user after providing a first one or more inputs to the machine learning model based on the current time, receiving the input from the user, and providing a second one or more inputs to the machine learning model based on the current time and the customer. For example, initial recommendations may have been determined based on outputs from the model in response to the first one or more inputs, and the initial recommendations may be replaced with updated recommendations based on outputs from the model in response to the second one or more inputs.

Operations 500 continue at step 506, with receiving one or more outputs from the machine learning model based on the one or more inputs.

Operations 500 continue at step 508, with selecting, based on the one or more outputs, a first recommended item from a plurality of items for inclusion in the document. In some embodiments, selecting the first recommended item comprises determining that the first recommended item corresponds to a highest score of a plurality of scores indicated by the one or more outputs.

Operations 500 continue at step 510, with determining a respective likelihood of each additional item of the plurality of items co-occurring with the first recommended item based on historical item co-occurrence data. According to some embodiments, determining the respective likelihood of each additional item of the plurality of items co-occurring with the first recommended item based on the historical item co-occurrence data comprises determining a frequency with which each given item co-occurs with the first recommended item in a plurality of historical documents of the user.

Operations 500 continue at step 512, with selecting, based on the one or more outputs and the respective likelihood of each additional item of the plurality of items co-occurring with the first recommended item, a second recommended item for inclusion in the document. In some embodiments, selecting the second recommended item comprises calculating a dynamic score for the second recommended item based on a given likelihood of the second recommended item co-occurring with the first recommended item and a score for the second recommended item that is indicated in the one or more outputs. For example, selecting the second recommended item may comprise determining that the dynamic score for the second recommended item is a highest of a plurality of dynamic scores corresponding to additional items of the plurality of items.

Operations 500 continue at step 514, with providing, via a user interface, the first recommended item and the second recommended item to the user. Certain embodiments further comprise receiving input from the user, via the user interface, that identifies a customer associated with the document. For example, the one or more inputs provided to the model may further be based on the customer.

Some embodiments further comprise receiving a selection or a rejection by the user via the user interface of the first recommended item or the second recommended item, and determining a subsequent recommended item for inclusion in the document or an additional document based on the machine learning model and the selection or the rejection. In an example, the machine learning model may be re-trained based on the selection or the rejection, and the re-trained machine learning model may be used to generate subsequent recommendations. In another example, recommendations may be updated based on a rejection such that co-occurrence with respect to the rejected item is no longer considered.

Notably, operations 500 is just one example with a selection of example steps, but additional methods with more, fewer, and/or different steps are possible based on the disclosure herein.

### Example Operations for Training a Machine Learning Model

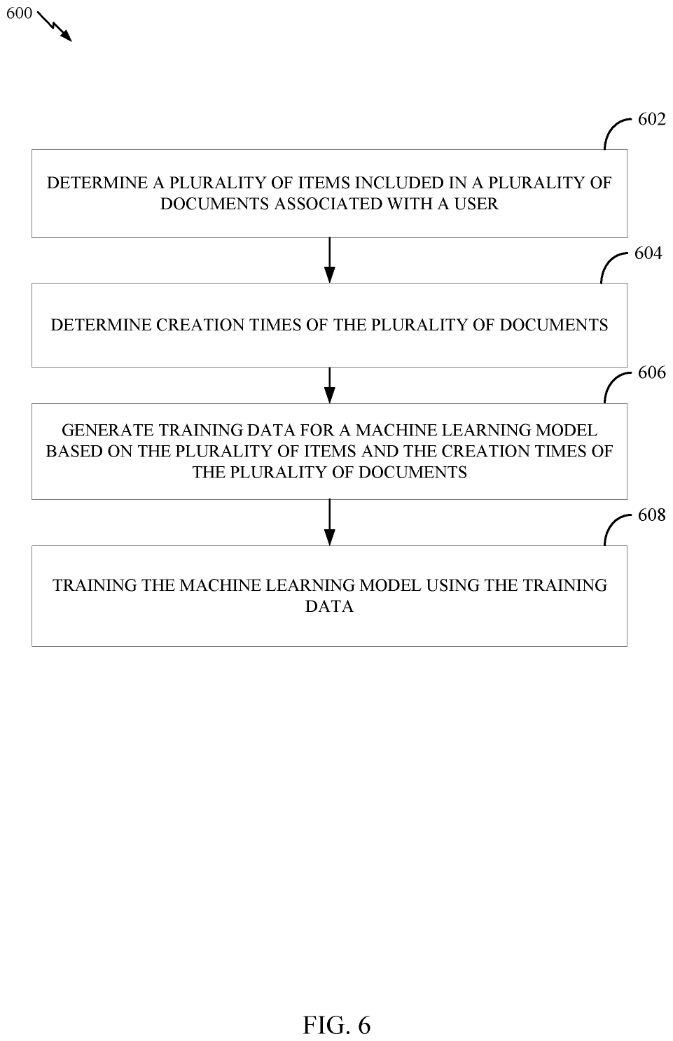

FIG. 6 depicts example operations 600 for training a machine learning model for dynamic electronic document creation assistance. For example, operations 600 may be performed by model trainer 620 of FIG. 6.

Operations 600 begin at step 602 with determining a plurality of items included in a plurality of documents associated with a user.

Operations 600 continue at step 604, with determining creation times of the plurality of documents.

Operations 600 continue at step 606, with generating training data for a machine learning model based on the plurality of items and the creation times of the plurality of documents. For example, the training data may comprise training inputs based on the creation times of the plurality of documents and labels based on whether each given item of the plurality of items is included in each given document of the plurality of documents. In some embodiments, generating the training inputs comprises determining one or more circular z scores based on the creation times of the plurality of documents. Creation times may include seconds, minutes, hours, days of week, days of month, days of year, and/or the like.

Operations 600 continue at step 608, with training the machine learning model using the training data. For example, training the machine learning model may include providing one or more inputs to the machine learning model based on the training inputs, receiving one or more outputs from the machine learning model based on the one or more inputs, and adjusting one or more parameters of the machine learning model based on comparing the one or more outputs to one or more of the labels.

Some embodiments further comprise receiving feedback from the user based on a given output from the machine learning model and re-training the machine learning model based on the feedback.

Notably, operations 600 is just one example with a selection of example steps, but additional methods with more, fewer, and/or different steps are possible based on the disclosure herein.

### Example Computing System

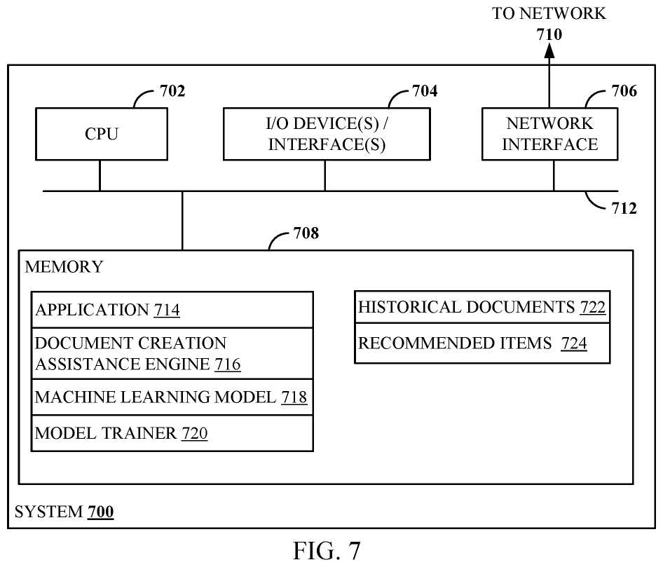

FIG. 7 illustrates an example system 700 with which embodiments of the present disclosure may be implemented. For example, system 700 may be configured to perform operations 400 of FIG. 4 and/or operations 500 of FIG. 5.

System 700 includes a central processing unit (CPU) 702, one or more I/O device interfaces 704 that may allow for the connection of various I/O devices 714 (e.g., keyboards, displays, mouse devices, pen input, etc.) to the system 700, network interface 706, a memory 708, and an interconnect 712. It is contemplated that one or more components of system 700 may be located remotely and accessed via a network 710. It is further contemplated that one or more components of system 700 may comprise physical components or virtualized components.

CPU 702 may retrieve and execute programming instructions stored in the memory 708. Similarly, the CPU 702 may retrieve and store application data residing in the memory 708. The interconnect 712 transmits programming instructions and application data, among the CPU 702, I/O device interface 704, network interface 706, and memory 708. CPU 702 is included to be representative of a single CPU, multiple CPUs, a single CPU having multiple processing cores, and other arrangements.

Additionally, the memory 708 is included to be representative of a random access memory or the like. In some embodiments, memory 708 may comprise a disk drive, solid state drive, or a collection of storage devices distributed across multiple storage systems. Although shown as a single unit, the memory 708 may be a combination of fixed and/or removable storage devices, such as fixed disc drives, removable memory cards or optical storage, network attached storage (NAS), or a storage area-network (SAN).

As shown, memory 708 includes application 714, document creation assistance engine 716, machine learning model 718, historical documents 722, and recommended items 724, which may be representative of application 220, document creation assistance engine 230, machine learning model 250, historical documents 242, and recommended items 234 of FIG. 2.

Memory 708 further comprises model trainer 720, which may perform operations related to training machine learning model 718, such as operations 500 of FIG. 5. In alternative embodiments, model trainer 720 is located on a different computing device than application 714 and/or other components depicted in memory 708. Generally, system 700 is a non-limiting example, and techniques described herein may be performed by more or fewer components located on one or more computing devices.

### Example Clauses

Clause 1: A method for electronic document creation assistance, comprising: determining a current time related to creation of a document by a user; providing one or more inputs to a machine learning model based on the current time; receiving one or more outputs from the machine learning model based on the one or more inputs; selecting, based on the one or more outputs, a first recommended item from a plurality of items for inclusion in the document; determining a respective likelihood of each additional item of the plurality of items co-occurring with the first recommended item based on historical item co-occurrence data; selecting, based on the one or more outputs and the respective likelihood of each additional item of the plurality of items co-occurring with the first recommended item, a second recommended item for inclusion in the document; and providing, via a user interface, the first recommended item and the second recommended item to the user.
Clause 2: The method of Clause 1, wherein the one or more inputs provided to the machine learning model comprise one or more of: an hour; a day of a month; a day of a week; a first score based on the hour and historical hours associated with historical documents; a second score based on the day of the month and historical days of months associated with the historical documents; or a third score based on the day of the week and historical days of weeks associated with the historical documents.
Clause 3: The method of Clause 2, wherein the first score, the second score, and the third score comprise circular z scores.
Clause 4: The method of any one of Clause 1-3, wherein selecting the first recommended item comprises determining that the first recommended item corresponds to a highest score of a plurality of scores indicated by the one or more outputs.
Clause 5: The method of any one of Clause 1-4, wherein determining the respective likelihood of each additional item of the plurality of items co-occurring with the first recommended item based on the historical item co-occurrence data comprises determining a frequency with which each given item co-occurs with the first recommended item in a plurality of historical documents of the user.
Clause 6: The method of any one of Clause 1-5, wherein selecting the second recommended item comprises: calculating a dynamic score for the second recommended item based on a given likelihood of the second recommended item co-occurring with the first recommended item and a score for the second recommended item that is indicated in the one or more outputs; and determining that the dynamic score for the second recommended item is a highest of a plurality of dynamic scores corresponding to additional items of the plurality of items.
Clause 7: The method of any one of Clause 1-6, further comprising receiving input from the user, via the user interface, that identifies a customer associated with the document, wherein the one or more inputs provided to the machine learning model are further based on the customer.
Clause 8: The method of Clause 7, wherein providing the one or more inputs to the machine learning model comprises: after providing a first one or more inputs to the machine learning model based on the current time, receiving the input from the user; and providing a second one or more inputs to the machine learning model based on the current time and the customer.
Clause 9: The method of any one of Clause 1-8, further comprising: receiving a selection or a rejection by the user via the user interface of the first recommended item or the second recommended item; and determining a subsequent recommended item for inclusion in the document or an additional document based on the machine learning model and the selection or the rejection.
Clause 10: A method for training a machine learning model, comprising: determining a plurality of items included in a plurality of documents associated with a user; determining creation times of the plurality of documents; generating training data for a machine learning model, the training data comprising: training inputs based on the creation times of the plurality of documents; and labels based on whether each given item of the plurality of items is included in each given document of the plurality of documents; and training the machine learning model using the training data by: providing one or more inputs to the machine learning model based on the training inputs; receiving one or more outputs from the machine learning model based on the one or more inputs; and adjusting one or more parameters of the machine learning model based on comparing the one or more outputs to one or more of the labels.
Clause 11: The method of Clause 10, further comprising: receiving feedback from the user based on a given output from the machine learning model; and re-training the machine learning model based on the feedback.
Clause 12: The method of any one of Clause 10-11, wherein generating the training inputs comprises determining one or more circular z scores based on the creation times of the plurality of documents.
Clause 13: A system for electronic document creation assistance, comprising: one or more processors; and a memory storing instructions that, when executed by the one or more processors, cause the system to: determine a current time related to creation of a document by a user; provide one or more inputs to a machine learning model based on the current time; receive one or more outputs from the machine learning model based on the one or more inputs; select, based on the one or more outputs, a first recommended item from a plurality of items for inclusion in the document; determine a respective likelihood of each additional item of the plurality of items co-occurring with the first recommended item based on historical item co-occurrence data; select, based on the one or more outputs and the respective likelihood of each additional item of the plurality of items co-occurring with the first recommended item, a second recommended item for inclusion in the document; and provide, via a user interface, the first recommended item and the second recommended item to the user.
Clause 14: The system of Clause 13, wherein the one or more inputs provided to the machine learning model comprise one or more of: an hour; a day of a month; a day of a week; a first score based on the hour and historical hours associated with historical documents; a second score based on the day of the month and historical days of months associated with the historical documents; or a third score based on the day of the week and historical days of weeks associated with the historical documents.
Clause 15: The system of Clause 14, wherein the first score, the second score, and the third score comprise circular z scores.
Clause 16: The system of any one of Clause 13-15, wherein selecting the first recommended item comprises determining that the first recommended item corresponds to a highest score of a plurality of scores indicated by the one or more outputs.
Clause 17: The system of any one of Clause 13-16, wherein determining the respective likelihood of each additional item of the plurality of items co-occurring with the first recommended item based on the historical item co-occurrence data comprises determining a frequency with which each given item co-occurs with the first recommended item in a plurality of historical documents of the user.
Clause 18: The system of any one of Clause 13-17, wherein selecting the second recommended item comprises: calculating a dynamic score for the second recommended item based on a given likelihood of the second recommended item co-occurring with the first recommended item and a score for the second recommended item that is indicated in the one or more outputs; and determining that the dynamic score for the second recommended item is a highest of a plurality of dynamic scores corresponding to additional items of the plurality of items.
Clause 19: The system of any one of Clause 13-18, wherein the instructions, when executed by the one or more processors, further cause the system to receive input from the user, via the user interface, that identifies a customer associated with the document, wherein the one or more inputs provided to the machine learning model are further based on the customer.
Clause 20: The system of Clause 19, wherein providing the one or more inputs to the machine learning model comprises: after providing a first one or more inputs to the machine learning model based on the current time, receiving the input from the user; and providing a second one or more inputs to the machine learning model based on the current time and the customer.

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method for electronic document creation assistance, comprising:
determining a current time related to creation of a document by a user;
providing one or more inputs to a machine learning model based on the current time;
receiving one or more outputs from the machine learning model based on the one or more inputs, wherein:
the machine learning model has been trained through a supervised learning process based on training data; and
a given training input of the training data was determined based on a circular distance from a historical document creation time of a plurality of historical document creation times to an average of the plurality of historical document creation times;
selecting, based on the one or more outputs, a first recommended item from a plurality of items for inclusion in the document;
determining a respective likelihood of each additional item of the plurality of items co-occurring with the first recommended item based on historical item co-occurrence data;
selecting, based on the one or more outputs and the respective likelihood of each additional item of the plurality of items co-occurring with the first recommended item, a second recommended item for inclusion in the document;
providing, via a user interface, the first recommended item and the second recommended item to the user; and
receiving feedback from the user based on a given output from the machine learning model, wherein the machine learning model is re-trained based on the feedback.

2. The method of claim 1, wherein the one or more inputs provided to the machine learning model comprise one or more of:
an hour;
a day of a month;
a day of a week;
a first score based on the hour and historical hours associated with historical documents;
a second score based on the day of the month and historical days of months associated with the historical documents; or
a third score based on the day of the week and historical days of weeks associated with the historical documents.

3. The method of claim 2, wherein the first score, the second score, and the third score comprise circular z scores.

4. The method of claim 1, wherein selecting the first recommended item comprises determining that the first recommended item corresponds to a highest score of a plurality of scores indicated by the one or more outputs.

5. The method of claim 1, wherein determining the respective likelihood of each additional item of the plurality of items co-occurring with the first recommended item based on the historical item co-occurrence data comprises determining a frequency with which each given item co-occurs with the first recommended item in a plurality of historical documents of the user.

6. The method of claim 1, wherein selecting the second recommended item comprises:
calculating a dynamic score for the second recommended item based on a given likelihood of the second recommended item co-occurring with the first recommended item and a score for the second recommended item that is indicated in the one or more outputs; and
determining that the dynamic score for the second recommended item is a highest of a plurality of dynamic scores corresponding to additional items of the plurality of items.

7. The method of claim 1, further comprising receiving input from the user, via the user interface, that identifies a customer associated with the document, wherein the one or more inputs provided to the machine learning model are further based on the customer.

8. The method of claim 7, wherein providing the one or more inputs to the machine learning model comprises:
after providing a first one or more inputs to the machine learning model based on the current time, receiving the input from the user; and
providing a second one or more inputs to the machine learning model based on the current time and the customer.

9. The method of claim 1, further comprising:
receiving a selection or a rejection by the user via the user interface of the first recommended item or the second recommended item; and
determining a subsequent recommended item for inclusion in the document or an additional document based on the machine learning model and the selection or the rejection.

10. A method for training a machine learning model, comprising:
determining a plurality of items included in a plurality of documents associated with a user;
determining creation times of the plurality of documents;
generating training data for a machine learning model, the training data comprising:
training inputs based on the creation times of the plurality of documents, wherein at least one training input of the training inputs was determined by computing a circular distance between a given creation time of the creation times and an average of the creation times; and
labels based on whether each given item of the plurality of items is included in each given document of the plurality of documents; and
training the machine learning model using the training data by:
providing one or more inputs to the machine learning model based on the training inputs;
receiving one or more outputs from the machine learning model based on the one or more inputs; and
adjusting one or more parameters of the machine learning model based on comparing the one or more outputs to one or more of the labels; and
retraining the machine learning model based on feedback from the user with respect to a given output from the machine learning model.

11. (canceled)

12. The method of claim 10, wherein generating the training inputs comprises determining one or more circular z scores based on the creation times of the plurality of documents.

13. A system for electronic document creation assistance, comprising:
one or more processors; and
a memory storing instructions that, when executed by the one or more processors, cause the system to:
determine a current time related to creation of a document by a user;
provide one or more inputs to a machine learning model based on the current time, wherein:
the machine learning model has been trained through a supervised learning process based on training data; and
a given training input of the training data was determined based on a circular distance from a historical document creation time of a plurality of historical document creation times to an average of the plurality of historical document creation times;
receive one or more outputs from the machine learning model based on the one or more inputs;
select, based on the one or more outputs, a first recommended item from a plurality of items for inclusion in the document;
determine a respective likelihood of each additional item of the plurality of items co-occurring with the first recommended item based on historical item co-occurrence data;
select, based on the one or more outputs and the respective likelihood of each additional item of the plurality of items co-occurring with the first recommended item, a second recommended item for inclusion in the document;
provide, via a user interface, the first recommended item and the second recommended item to the user; and
receive feedback from the user based on a given output from the machine learning model, wherein the machine learning model is re-trained based on the feedback.

14. The system of claim 13, wherein the one or more inputs provided to the machine learning model comprise one or more of:
an hour;
a day of a month;
a day of a week;
a first score based on the hour and historical hours associated with historical documents;
a second score based on the day of the month and historical days of months associated with the historical documents; or
a third score based on the day of the week and historical days of weeks associated with the historical documents.

15. The system of claim 14, wherein the first score, the second score, and the third score comprise circular z scores.

16. The system of claim 13, wherein selecting the first recommended item comprises determining that the first recommended item corresponds to a highest score of a plurality of scores indicated by the one or more outputs.

17. The system of claim 13, wherein determining the respective likelihood of each additional item of the plurality of items co-occurring with the first recommended item based on the historical item co-occurrence data comprises determining a frequency with which each given item co-occurs with the first recommended item in a plurality of historical documents of the user.

18. The system of claim 13, wherein selecting the second recommended item comprises:
calculating a dynamic score for the second recommended item based on a given likelihood of the second recommended item co-occurring with the first recommended item and a score for the second recommended item that is indicated in the one or more outputs; and
determining that the dynamic score for the second recommended item is a highest of a plurality of dynamic scores corresponding to additional items of the plurality of items.

19. The system of claim 13, wherein the instructions, when executed by the one or more processors, further cause the system to receive input from the user, via the user interface, that identifies a customer associated with the document, wherein the one or more inputs provided to the machine learning model are further based on the customer.

20. The system of claim 19, wherein providing the one or more inputs to the machine learning model comprises:
after providing a first one or more inputs to the machine learning model based on the current time, receiving the input from the user; and
providing a second one or more inputs to the machine learning model based on the current time and the customer.
